(19) United States
(12) Patent Application Publication
(10) Pub. No.: US 2009/0259607 A1
(43) Pub. Date: Oct. 15, 2009

(54) SYSTEM, METHOD, AND PROGRAM FOR EVALUATING PERFORMANCE OF INTERMOLECULAR INTERACTION PREDICTING APPARATUS

(76) Inventors: Hiroaki Fukunishi, Tokyo (JP); Reiji Teramoto, Tokyo (JP); Jirou Shimada, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/312,546

(22) PCT Filed: Nov. 9, 2007
(86) PCT No.: PCT/JP2007/071781

§ 371 Date: May 15, 2009

(30) Foreign Application Priority Data
Nov. 24, 2006 (JP) 2006-317348

(51) Int. Cl. G06F 15/18; G06G 7/48

(52) U.S. Cl. 706/20; 703/11; 706/21

(57) ABSTRACT

The present invention provides a system, method, and program for evaluating the performance of an intermolecular interaction predicting apparatus. A performance evaluation system evaluates the performance of an intermolecular interaction predicting apparatus using a correlation between structure factors and physicochemical parameters of classification model construction compounds with high and low scores calculated by the intermolecular interaction predicting apparatus.

### TECHNICAL FIELD

The present invention relates to a system, method, and program for evaluating the performance of an intermolecular interaction predicting apparatus, and more particularly, to a system, method, and program for evaluating the performance of an intermolecular interaction predicting apparatus using a correlation between structure factors and physicochemical parameters of compounds with high and low prediction scores calculated by the intermolecular interaction predicting apparatus.

### BACKGROUND ART

An intermolecular interaction predicting apparatus has been used widely as means for effectively discovering a new drug. For example, various models from a coarse-grained model to a strict model, such as a docking simulation, a molecular dynamics method, and a molecular orbital method, are used for the intermolecular interaction predicting apparatus. As strictness is increased, a variation in calculation time is increased. Therefore, it should be careful in use of an intermolecular interaction predicting apparatus according to purposes.

In a screening step of a large compound database, which is an initial step of the discovery of a new drug, it is important to perform screening at a high speed. Therefore, a docking simulation without high strictness is performed. The screening step rather performs enrichment to increase the probability of discovering a compound having interaction than accurately calculates the interaction between the compounds.

In recent years, various docking simulation software components with different methodologies have been proposed. For example, Non-Patent Document 1 discloses FlexX, and Non-Patent Document 2 discloses Glide. In addition, the performances of the docking simulation software components have been evaluated by many general users.

There is enrichment as a representative index of performance evaluation, and is represented by a graph shown in FIG. 1. In the graph, the horizontal axis indicates the top x % of the compounds ranked based on prediction scores. The vertical axis indicates the ratio of compounds that are truly active to all the compounds. As the enrichment is increased, the probability of including an active compound is increased.

For example, when the top 10% of 1000 compounds in a database with higher prediction scores are extracted (when 100 compounds are extracted from 1000 compounds), it is possible to evaluate, for example, whether 100% of true active compounds are included or 5% of true active compounds are included.

Non-Patent Document 1: Rarey, M.; Kramer, B.; Lengauer, T.; Klebe, G. A fast flexible docking method using an incremental construction algorithm. J. Mol. Biol. 1996, 261, 470-489.

Non-Patent Document 2: Friesner, R. A.; Banks, J. L.; Murphy, R. B.; Halgren, T. A.; Klicic, J. J.; Mainz, D. T.; Repasky, M. P.; Knoll, E. H.; Shelley, M.; Perry, J. K.; Shaw, D. E.; Francis, P.; Shenkin, P. S. Glide: a new approach for rapid, accurate docking and scoring. 1. Method and assessment of docking accuracy. J. Med. Chem. 2004, 47, 1739-1749.

### DISCLOSURE OF THE INVENTION

### Problem to be Solved by the Invention

However, the related art has the following problems.

In the related art, only the prediction score that is directly obtained from the intermolecular interaction predicting apparatus is used to evaluate the performance of the intermolecular interaction predicting apparatus.

Therefore, an exemplary object of the present invention is to provide a system, method, and program for evaluating the performance of an intermolecular interaction predicting apparatus using a correlation between structure factors and physicochemical parameters of compounds with high and low prediction scores calculated by the intermolecular interaction predicting apparatus.

### Means for Solving the Problem

According to a first exemplary aspect of the present invention, there is provided a system for evaluating the performance of an intermolecular interaction predicting apparatus using a correlation between structure factors and physicochemical parameters of classification model construction compounds with high and low scores calculated by the intermolecular interaction predicting apparatus.

According to a second exemplary aspect of the present invention, a system for evaluating the performance of an intermolecular interaction predicting apparatus includes a classifying device, wherein the classifying device includes: classification model construction means for learning a classification model having a high or low score as a target attribute, and structure factors and physicochemical parameters as description attributes; and classification model evaluation means for evaluating the constructed classification model.

According to a third exemplary aspect of the present invention, there is provided a method of evaluating the performance of an intermolecular interaction predicting apparatus using a correlation between structure factors and physicochemical parameters of classification model construction compounds with high and low scores calculated by the intermolecular interaction predicting apparatus in a performance evaluation system.

According to a fourth exemplary aspect of the present invention, there is provided a method of evaluating the performance of an intermolecular interaction predicting apparatus in a performance evaluation system including a classifying device that evaluates the performance of the intermolecular interaction predicting apparatus using a correlation between structure factors and physicochemical parameters of classification model construction compounds with high and low scores calculated by the intermolecular interaction predicting apparatus, wherein the classifying device includes: a classification model construction step of learning a classification model having a high or low score as a target attribute, and structure factors and physicochemical parameters as description attributes; and a classification model evaluating step of evaluating the constructed classification model.

According to a fifth exemplary aspect of the present invention, there is provided a performance evaluating program for allowing a performance evaluation system to evaluate the performance of an intermolecular interaction predicting apparatus using a correlation between structure factors and physicochemical parameters of classification model construction compounds with high and low scores calculated by the intermolecular interaction predicting apparatus.

According to a sixth exemplary aspect of the present invention, there is provided a performance evaluating program for allowing a classifying device of a performance evaluation system to evaluate the performance of an intermolecular interaction predicting apparatus using a correlation between structure factors and physicochemical parameters of classification model construction compounds with high and low scores calculated by the intermolecular interaction predicting apparatus, wherein the classifying device includes: a classification model construction step of learning a classification model having a high or low score as a target attribute, and the structure factors and the physicochemical parameters as description attributes; and a classification model evaluating process of evaluating the constructed classification model.

### EFFECTS OF THE INVENTION

According to the present invention, it is possible to evaluate the performance of an intermolecular interaction predicting apparatus using a correlation between structure factors and physicochemical parameters of the compounds with high and low prediction scores calculated by the intermolecular interaction predicting apparatus.

### BEST MODE FOR CARRYING OUT THE INVENTION

Hereinafter, the structure and operation of a system for evaluating the performance of an intermolecular interaction predicting apparatus according to the present invention will be described.

First, the structure of the system for evaluating the performance of the intermolecular interaction predicting apparatus according to the present invention will be described with reference to FIG. 2.

The system for evaluating the performance of the intermolecular interaction predicting apparatus according to the present invention includes an input device 1, a classifying device 2, a storage device 3, and an output device 4.

The classifying device 2 includes classification model construction means 21 that learns a classification model having activation or inactivation as a target attribute, and structure factors and physicochemical parameters as description attributes, and classification model evaluation means 22 that evaluates the performance of a constructed classification model. Machine learning includes learning with a teacher and learning without a teacher. For example, a decision tree, ensemble learning, a neural network, a support vector machine, or regression analysis can be applied to the learning with a teacher. For example, clustering or main component analysis can be applied to the learning without a teacher.

The storage device 3 includes: a classification model construction compound prediction score ranking list storage unit 31 that stores whether the score of a classification model construction compound predicted by the intermolecular interaction predicting apparatus is high or low; a classification model construction compound descriptor storage unit 32 that stores descriptors indicating the structure factors and physicochemical parameters of a classification model construction compound used for the learning of a classification model; a classification model evaluation compound descriptor storage unit 33 that stores descriptors indicating the structure factors and physicochemical parameters of a classification model evaluation compound used for evaluating a constructed classification model; and a classification model evaluation compound active/inactive list storage unit 34 that stores whether a classification model evaluation compound is active or inactive. In addition, in the classification model construction compound prediction score ranking list storage unit 31, compounds are used for target attributes of a molecular model construction unit, regarding a compound having a high score as an active compound and a compound having a low score as an inactive compound.

The performance of the intermolecular interaction predicting apparatus having the above-mentioned structure can be evaluated by the correlation between the structure factors and the physicochemical parameters of the compounds with high and low prediction scores calculated by the intermolecular interaction predicting apparatus.

Next, a system for evaluating the performance of an intermolecular interaction predicting apparatus according to a preferred exemplary embodiment of the present invention will be described.

First, the detailed structure of the system for evaluating the performance of an intermolecular interaction predicting apparatus according to the exemplary embodiment will be described with reference to FIG. 3.

The system for evaluating the performance of an intermolecular interaction predicting apparatus according to the exemplary embodiment includes an input device 1, such as a keyboard, an intermolecular interaction predicting apparatus 5 to be subjected to performance evaluation, a classifying device 2, a storage device 3, a descriptor allocating device 6, and an output device 4, such as a display device or a printing device.

The intermolecular interaction predicting apparatus includes bond structure generating means 51 that generates a bond structure between a receptor and a compound and score calculating means 52 that calculates the score (binding free energy) of the bond structure generated by the bond structure generating means 51.

The classifying device 2 includes: classification model construction means 21 that learns a classification model having activation or inactivation as a target attribute and structure factors and physicochemical parameters as description attributes; and classification model evaluation means 22 that evaluates the performance of a constructed classification model. Machine learning includes learning with a teacher and learning without a teacher. For example, a decision tree, ensemble learning, a neural network, a support vector machine, or regression analysis can be applied to the learning with a teacher. For example, clustering or main component analysis can be applied to the learning without a teacher.

The storage device 3 includes: a receptor storage unit 35 that stores a target receptor; a classification model construction compound storage unit 36 that stores a compound whose score is calculated by the intermolecular interaction predicting apparatus in order to construct a classification model; a classification model evaluation compound storage unit 37 that stores a compound used for evaluating a classification model; a classification model construction compound prediction score ranking list storage unit 31 that stores whether the score of a classification model construction compound predicted by the intermolecular interaction predicting apparatus is high or low; a classification model construction compound descriptor storage unit 32 that stores descriptors indicating the structure factors and physicochemical parameters of a classification model construction compound used for the learning of a classification model; a classification model prediction compound descriptor storage unit 33 that stores descriptors indicating the structure factors and physicochemical parameters of a classification model evaluation compound used for evaluating a constructed classification model; and a classification model evaluation compound active/inactive list storage unit 34 that stores whether a classification model evaluation compound is active or inactive. In the classification model construction compound prediction score ranking list storage unit 31, compounds are used for target attributes of molecular model construction means 21, regarding a compound having a high score as an active compound and a compound having a low score as an inactive compound.

Next, the operation of the system for evaluating the performance of the intermolecular interaction predicting apparatus according to the exemplary embodiment will be described in detail with reference to FIGS. 3 and 4.

First, when an instruction to evaluate the performance of an intermolecular interaction predicting apparatus is input from the input device 1, the bond structure generating means 51 generates a bond structure between a receptor and a compound (Step A1). When the bond structure is generated, the score calculating means 52 calculates the score of the generated bond structure (Step A2). The scores of all the compounds stored in the classification model construction compound storage unit 36 are calculated (Step A3/YES), and a list of compounds having high scores and compounds having low scores is stored in the classification model construction compound prediction score ranking list storage unit 31.

Then, the descriptor allocating device 6 allocates descriptors indicating structure factors and physicochemical parameters to all the compounds stored in the classification model construction compound storage unit 36 (Step A4 and Step A5). The descriptors allocated to all the compounds are stored in the classification model construction compound descriptor storage unit 32.

Then, the descriptor allocating device 6 allocates descriptors indicating structure factors and physicochemical parameters to all the compounds stored in the classification model evaluation compound storage unit 37 (Step A6 and Step A7). The descriptors allocated to all the compounds are stored in the classification model evaluation compound descriptor storage unit 33.

Then, data stored in the classification model construction compound prediction score ranking list storage unit 31 and data stored in the classification model construction compound descriptor storage unit 32 are used to construct a classification model having activation or inactivation as a target attribute and structure factors and physicochemical parameters as description attributes (Step A8). In this case, the compounds stored in the classification model construction compound prediction score ranking list storage unit 31 are used for the target attributes, regarding a compound having a high score as an active compound and a compound having a low score as an inactive compound. Machine learning includes learning with a teacher and learning without a teacher. For example, a decision tree, ensemble learning, a neural network, a support vector machine, or regression analysis can be applied to the learning with a teacher. For example, clustering or main component analysis can be applied to the learning without a teacher.

Then, data stored in the classification model evaluation compound descriptor storage unit 33 and data stored in the true active/inactive list storage unit 34 of the classification model evaluation compound are used to compare the result of the constructed classification model with a true result, thereby evaluating the performance of the classification model (Step A9).

### EXAMPLES

Next, an example of the present invention will be described with reference to the drawings. The example of the present invention corresponds to the above-described exemplary embodiment. An object of the example is to evaluate the performance of a scoring function and compare the functions of a plurality of scoring functions.

In this example, a keyboard is used as the input device 1, a personal computer is used as a processing apparatus including the intermolecular interaction predicting apparatus 5, the classifying device 2, and the descriptor allocating device 6, a magnetic disk storage device is used as the storage device 3, and a display is used as the output device 4. The personal computer includes a central processing unit, and the magnetic disk storage device stores a receptor, a classification model construction compound, a classification model evaluation compound, a classification model construction descriptor, and a classification model evaluation descriptor.

TABLE 1

| Target receptor | Estrogen receptor (ER) |
|---|---|
| Classification model | 1000 compounds (selected at random from a lead-like |
| construction compound | compound library of a compound database ZINC) |
| Classification model | 1000 compounds: |
| evaluation compound | 10 compounds (known active compounds of ER) |
| | 990 compounds (selected at random from a lead-like |
| | compound library of a compound database ZINC) |
| Bond structure | FlexXSIS |
| generating means | |
| Score calculating means | 5 scoring functions: FlexX Score, D-Score, PMF, |
| | G-Score, ChemScore |
| Descriptor allocating | JOELib (capable of allocating 101 descriptors) |
| device | |
| Classification model | Decision tree J48 (module of a learning algorithm |
| | integration system Weka) |
| Threshold value of | 100 |
| activation | |

The conditions of this example are shown in Table 1. An estrogen receptor (ER) was used as a target receptor. 1000 compounds that were selected at random from a lead-like compound library of a compound database ZINC were used as the classification model construction compounds. 10 known active compounds of ER and 990 compounds selected at random from the lead-like compound library of the compound database ZINC were used as the classification model evaluation compounds (however, except for compounds selected for the classification model construction compounds).

FlexXSIS was used as the bond structure generating unit 51, and 5 scoring functions (FlexX, D-score, PMF, G-score, and ChemScore) were used as the score calculating unit 52. The FlexXSIS and 5 scoring functions can be used as a module of SYBYL manufactured by Tripos, Inc. JOELib capable of allocating 101 2D descriptors was used as the descriptor allocating device 6. A decision tree J48 included in a module of a machine learning integration system Weka was used as the classification model. The threshold value of activation for the ranking obtained by the intermolecular interaction predicting apparatus 5 was 100. That is, the top 100 compounds are regarded as active compounds, and the other 900 compounds are regarded as inactive compounds. In addition, learning with a teacher is performed.

The performance is evaluated by an enrichment factor (EF) represented by the following expression:

EF=(Asample/Nsample)/(Atotal/Ntotal),

Nsample: the number of all compounds classified as active compounds by a classification model,

Asample: the number of compounds that are truly active among the compounds classified as active compounds by a classification model,

Atotal: the number of compounds that are truly active among the classification model evaluation compounds, and

Ntotal: the number of all classification model evaluation compounds.

This index indicates the accuracy rate of the number of compounds predicted as active compounds to the number of active compounds extracted at random. That is, as the value is increased, the performance of a classification model is improved. Table 2 shows EF of a classification model obtained from the results of each of the scoring functions.

TABLE 2

| | C_{FlexX Score} | C_{D-Score} | C_{PMF} | C_{G-Score} | C_{ChemScore} |
|---|---|---|---|---|---|
| EF | 13.8 | 36.8 | 0 | 6.5 | 13.8 |

CFlexX Score: a classification model learned by the result of FlexX score,

CD-Score: a classification model learned by the result of D-score,

CPMF: a classification model learned by the result of PMF,

CG-Score: a classification model learned by the result of G-score, and

CChemScore: a classification model learned by the result of ChemScore.

Next, the performances of the classification models are compared with each other from the results of Table 2. As a result, the following relationship is obtained: CD-Score>CFlexXScore=CChemScore>CG-Score>CPMF. Since the classification models are learned by the ranking results of the compounds predicted by the scoring functions, the performances of the scoring functions satisfy the following relationship: D-Score>FlexXScore=ChemScore>G-Score>PMF.

In this way, the performance of the intermolecular interaction predicting apparatus was evaluated by the correlation between the structure factors and the physicochemical parameters of the compounds with high and low prediction scores calculated by the intermolecular interaction predicting apparatus.

As such, according to a first exemplary aspect of the present invention, there is provided a system for evaluating the performance of an intermolecular interaction predicting apparatus using a correlation between structure factors and physicochemical parameters of classification model construction compounds with high and low scores calculated by the intermolecular interaction predicting apparatus.

According to a second exemplary aspect of the present invention, there is provided a system for evaluating the performance of an intermolecular interaction predicting apparatus includes a classifying device, wherein the classifying device includes: classification model construction means for learning a classification model having a high or low score as a target attribute, and structure factors and physicochemical parameters as description attributes; and classification model evaluation means for evaluating the constructed classification model.

The system for evaluating the performance of an intermolecular interaction predicting apparatus according to the above-mentioned exemplary aspect further may include a storage device, wherein the storage device may include: classification model construction compound prediction score ranking list storage means for storing whether the score of the classification model construction compound calculated by the intermolecular interaction predicting apparatus is high or low; classification model construction compound descriptor storage means for storing descriptors indicating the structure factors and the physicochemical parameters of the classification model construction compound used to construct a classification model; classification model evaluation compound active/inactive list storage means for storing whether a classification model evaluation compound is active or inactive; and classification model evaluation compound descriptor storage means for storing descriptors indicating the structure factors and the physicochemical parameters of a classification model evaluation compound compared with the classification model. The classification model construction means may learn the classification model based on whether the score of the classification model construction compound is high or low and the structure factors and the physicochemical parameters of the classification model construction compound, and the classification model evaluation means may evaluate the classification model based on whether the classification model evaluation compound is active or inactive and the structure factors and the physicochemical parameters of the classification model evaluation compound.

In the system for evaluating the performance of an intermolecular interaction predicting apparatus according to the above-mentioned exemplary aspect, when a prediction score is high, the classification model construction means may set the target attribute of the classification model construction compound as active. When the prediction score is low, the classification model construction means may set the target attribute of the classification model construction compound as inactive.

The system for evaluating the performance of an intermolecular interaction predicting apparatus according to the above-mentioned exemplary aspect may further include an intermolecular interaction predicting apparatus that includes bond structure generating means and score calculating means, wherein the storage device may further include: receptor storage means for storing a receptor; and classification model construction compound storage means for storing the classification model construction compound for predicting interaction, the bond structure generating means may generate bond structures between the receptor stored in the receptor storage means and all the classification model construction compounds stored in the classification model construction compound storage means, and the score calculating means may calculate the scores of all the bond structures generated by the bond structure generating means.

The system for evaluating the performance of an intermolecular interaction predicting apparatus according to the above-mentioned exemplary aspect may further include a descriptor allocating device, wherein the storage device may further include classification model evaluation compound storage means for storing the classification model evaluation compound used to evaluate the classification model, the descriptor allocating device may allocate descriptors indicating structure factors and physicochemical parameters to each of the classification model construction compounds stored in the classification model construction compound storage means, and store the descriptors in the classification model construction compound descriptor storage means, and the descriptor allocating device may allocate descriptors indicating structure factors and physicochemical parameters to each of the classification model evaluation compounds stored in the classification model evaluation compound storage means and store the descriptors in the classification model evaluation compound descriptor storage means.

In the system for evaluating the performance of an intermolecular interaction predicting apparatus according to the above-mentioned exemplary aspect, the score calculating means may calculate the binding free energy of the bond structure.

In the system for evaluating the performance of an intermolecular interaction predicting apparatus according to the above-mentioned exemplary aspect, in a learning method with a teacher, the classification model construction means may use a decision tree, ensemble learning, a neural network, a support vector machine, or regression analysis as machine learning, and in a learning method without a teacher, the classification model construction means may use clustering or main component analysis as the machine learning.

According to a third exemplary aspect of the present invention, there is provided a method of evaluating the performance of an intermolecular interaction predicting apparatus using a correlation between structure factors and physicochemical parameters of classification model construction compounds with high and low scores calculated by the intermolecular interaction predicting apparatus in a performance evaluation system.

According to a fourth exemplary aspect of the present invention, there is provided a method of evaluating the performance of an intermolecular interaction predicting apparatus in a performance evaluation system including a classifying device that evaluates the performance of the intermolecular interaction predicting apparatus using a correlation between structure factors and physicochemical parameters of classification model construction compounds with high and low scores calculated by the intermolecular interaction predicting apparatus, wherein the classifying device includes: a classification model construction step of learning a classification model having a high or low score as a target attribute, and structure factors and physicochemical parameters as description attributes; and a classification model evaluating step of evaluating the constructed classification model.

In the method of evaluating the performance of an intermolecular interaction predicting apparatus in the performance evaluation system according to the above-mentioned exemplary aspect, the system for evaluating the performance of the intermolecular interaction predicting apparatus may further include a storage device. The storage device may include: classification model construction compound prediction score ranking list storage means for storing whether the score of the classification model construction compound calculated by the intermolecular interaction predicting apparatus is high or low; classification model construction compound descriptor storage means for storing descriptors indicating the structure factors and the physicochemical parameters of the classification model construction compound used to construct a classification model; classification model evaluation compound active/inactive list storage means for storing whether a classification model evaluation compound is active or inactive; and classification model evaluation compound descriptor storage means for storing descriptors indicating the structure factors and the physicochemical parameters of a classification model evaluation compound compared with the classification model. The classification model construction step may include a step of learning the classification model based on whether the score of the classification model construction compound is high or low and the structure factors and the physicochemical parameters of the classification model construction compound, and the classification model evaluating step may include a step of evaluating the classification model based on whether the classification model evaluation compound is active or inactive and the structure factors and the physicochemical parameters of the classification model evaluation compound.

In the method of evaluating the performance of an intermolecular interaction predicting apparatus in the performance evaluation system according to the above-mentioned exemplary aspect, when a prediction score is high, the classification model construction step may set the target attribute of the classification model construction compound as active. When the prediction score is low, the classification model construction step may set the target attribute of the classification model construction compound as inactive.

In the method of evaluating the performance of an intermolecular interaction predicting apparatus in the performance evaluation system according to the above-mentioned exemplary aspect, the storage device may further include: receptor storage means for storing a receptor; and classification model construction compound storage means for storing the classification model construction compound for predicting interaction. The intermolecular interaction predicting apparatus may include: a bond structure generating step of generating bond structures between the receptor stored in the receptor storage means and all the classification model construction compounds stored in the classification model construction compound storage means; and a score calculating step of calculating the scores of all the bond structures generated in the bond structure generating step.

The method of evaluating the performance of an intermolecular interaction predicting apparatus in the performance evaluation system according to the above-mentioned exemplary aspect may include a descriptor allocating step of allocating descriptors indicating structure factors and physicochemical parameters to each of the classification model construction compounds stored in the classification model construction compound storage means, storing the descriptors in the classification model construction compound descriptor storage means, allocating descriptors indicating structure factors and physicochemical parameters to each of the classification model evaluation compounds stored in a classification model evaluation compound storage means that is provided in the storage device and stores the classification model evaluation compounds used to evaluate the classification model, and storing the descriptors in the classification model evaluation compound descriptor storage means.

In the method of evaluating the performance of an intermolecular interaction predicting apparatus in the performance evaluation system according to the above-mentioned exemplary aspect, the score calculating step may calculate the binding free energy of the bond structure.

In the method of evaluating the performance of an intermolecular interaction predicting apparatus in the performance evaluation system according to the above-mentioned exemplary aspect, in a learning method with a teacher, the classification model construction step may use a decision tree, ensemble learning, a neural network, a support vector machine, or regression analysis as machine learning, and in a learning method without a teacher, the classification model construction step may use clustering or main component analysis as the machine learning.

According to a fifth exemplary aspect of the present invention, there is provided a performance evaluating program for allowing a performance evaluation system to evaluate the performance of an intermolecular interaction predicting apparatus using a correlation between structure factors and physicochemical parameters of classification model construction compounds with high and low scores calculated by the intermolecular interaction predicting apparatus.

According to a sixth exemplary aspect of the present invention, there is provided a performance evaluating program for allowing a classifying device of a performance evaluation system to evaluate the performance of an intermolecular interaction predicting apparatus using a correlation between structure factors and physicochemical parameters of classification model construction compounds and high and low scores calculated by the intermolecular interaction predicting apparatus, wherein the classifying device includes: a classification model construction process of learning a classification model having a high or low score as a target attribute, and the structure factors and the physicochemical parameters as description attributes; and a classification model evaluating process of evaluating the constructed classification model.

In the performance evaluating program for allowing the performance evaluation system to evaluate the performance of the intermolecular interaction predicting apparatus according to the above-mentioned exemplary aspect, the performance evaluation system of the intermolecular interaction predicting apparatus may further include a storage device. The storage device may include: classification model construction compound prediction score ranking list storage means for storing whether the score of the classification model construction compound calculated by the intermolecular interaction predicting apparatus is high or low; classification model construction compound descriptor storage means for storing descriptors indicating the structure factors and the physicochemical parameters of the classification model construction compound used to construct a classification model; classification model evaluation compound active/inactive list storage means for storing whether a classification model evaluation compound is active or inactive; and classification model evaluation compound descriptor storage means for storing descriptors indicating the structure factors and the physicochemical parameters of a classification model evaluation compound compared with the classification model. The classification model construction process may include a process of learning the classification model based on whether the score of the classification model construction compound is high or low and the structure factors and the physicochemical parameters of the classification model construction compound. The classification model evaluating process may include a process of evaluating the classification model based on whether the classification model evaluation compound is active or inactive and the structure factors and the physicochemical parameters of the classification model evaluation compound.

In the performance evaluating program for allowing the performance evaluation system to evaluate the performance of the intermolecular interaction predicting apparatus according to the above-mentioned exemplary aspect, when a prediction score is high, the classification model construction process may set the target attribute of the classification model construction compound as active. When the prediction score is low, the classification model construction process may set the target attribute of the classification model construction compound as inactive.

In the performance evaluating program for allowing the performance evaluation system to evaluate the performance of the intermolecular interaction predicting apparatus according to the above-mentioned exemplary aspect, the storage device may further include: receptor storage means for storing a receptor; and a classification model construction compound storage means for storing the classification model construction compound for predicting interaction. The intermolecular interaction predicting apparatus may include: a bond structure generating process of generating bond structures between the receptor stored in the receptor storage means and all the classification model construction compounds stored in the classification model construction compound storage means; and a score calculating process of calculating the scores of all the bond structures generated in the bond structure generating process.

The performance evaluating program for allowing the performance evaluation system to evaluate the performance of the intermolecular interaction predicting apparatus according to the above-mentioned exemplary aspect may further include a descriptor allocating process of allocating descriptors indicating structure factors and physicochemical parameters to each of the classification model construction compounds stored in the classification model construction compound storage means, storing the descriptors in the classification model construction compound descriptor storage means, allocating descriptors indicating structure factors and physicochemical parameters to each of the classification model evaluation compounds stored in a classification model evaluation compound storage means that is provided in the storage device and stores the classification model evaluation compounds used to evaluate the classification model, and storing the descriptors in the classification model evaluation compound descriptor storage means.

In the performance evaluating program for allowing the performance evaluation system to evaluate the performance of the intermolecular interaction predicting apparatus according to the above-mentioned exemplary aspect, the score calculating process may calculate the binding free energy of the bond structure.

In the performance evaluating program for allowing the performance evaluation system to evaluate the performance of the intermolecular interaction predicting apparatus according to the above-mentioned exemplary aspect, in a learning method with a teacher, the classification model construction process may use a decision tree, ensemble learning, a neural network, a support vector machine, or regression analysis as machine learning, and in a learning method without a teacher, the classification model construction process may use clustering or main component analysis as the machine learning.

The exemplary embodiment of the present invention has been described above, but the present invention is not limited thereto. It will be understood those skilled in the art that the structure or details of the present invention can be changed without departing from the scope of the present invention.

This application is based upon and claims the benefit of priority from Japanese patent application No. 2006-317348, filed on Nov. 24, 2006, the disclosure of which is incorporated herein in its entirety by reference.

### BRIEF DESCRIPTION OF THE DRAWINGS

FIG. 1 is a graph illustrating enrichment (J. Med. Chem. 2001, 44, 1035);

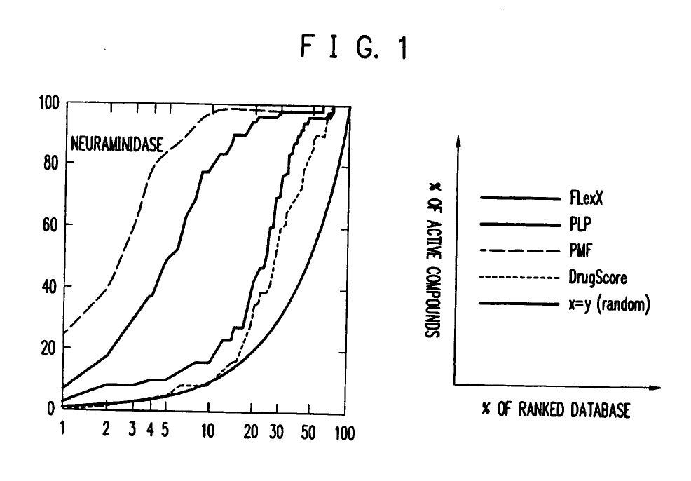

FIG. 2 is a block diagram illustrating the structure of a system for evaluating the performance of an intermolecular interaction predicting apparatus according to the present invention;

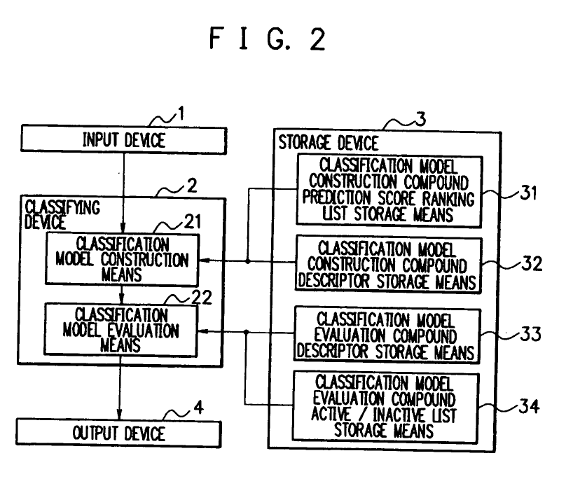

FIG. 3 is a block diagram illustrating the structure of a system for evaluating the performance of an intermolecular interaction predicting apparatus according to an exemplary embodiment of the present invention; and

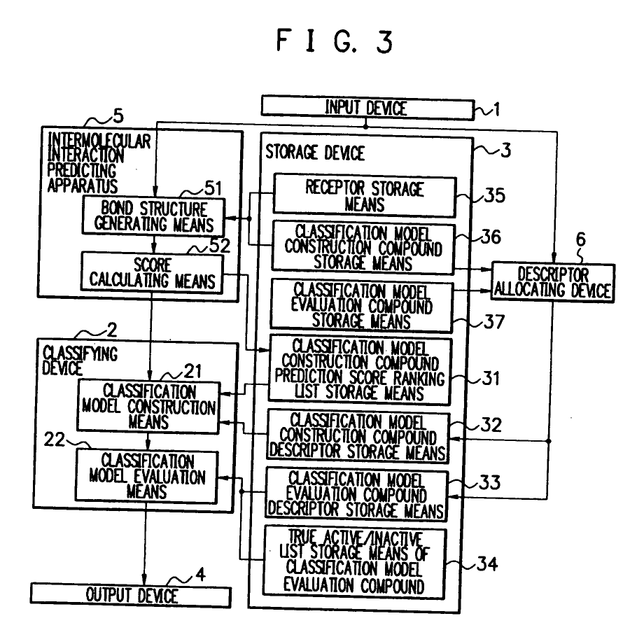

FIG. 4 is a flowchart illustrating the operation of the system for evaluating the performance of an intermolecular interaction predicting apparatus according to the exemplary embodiment.

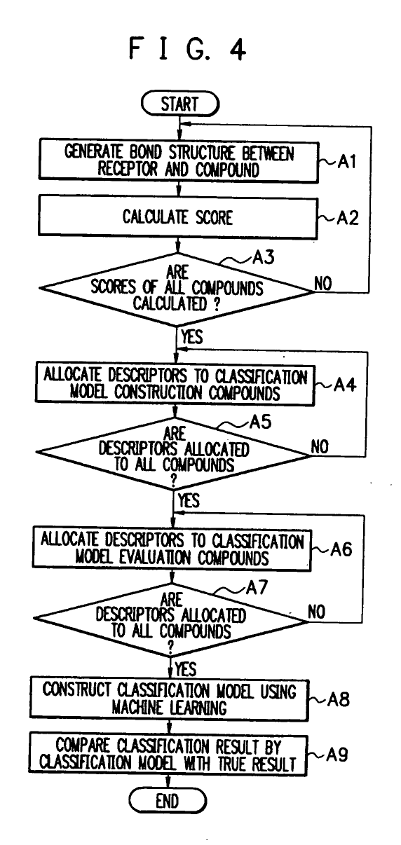

### REFERENCE NUMERALS

1 INPUT DEVICE
2 CLASSIFYING DEVICE
3 STORAGE DEVICE
4 OUTPUT DEVICE
5 INTERMOLECULAR INTERACTION PREDICTING APPARATUS
6 DESCRIPTOR ALLOCATING DEVICE

1. A system for evaluating the performance of an intermolecular interaction predicting apparatus using a correlation between structure factors and physicochemical parameters of classification model construction compounds with high and low scores calculated by the intermolecular interaction predicting apparatus.

2. A system for evaluating the performance of an intermolecular interaction predicting apparatus, comprising a classifying device including: a classification model construction unit that learns a classification model having a high or low score as a target attribute, and structure factors and physicochemical parameters as description attributes; and a classification model evaluation unit that evaluates the constructed classification model.

3. The system for evaluating the performance of an intermolecular interaction predicting apparatus according to claim 2, further comprising a storage device including: a classification model construction compound prediction score ranking list storage unit that stores whether the score of the classification model construction compound calculated by the intermolecular interaction predicting apparatus is high or low; a classification model construction compound descriptor storage unit that stores descriptors indicating the structure factors and the physicochemical parameters of the classification model construction compound used to construct a classification model; a classification model evaluation compound active/inactive list storage unit that stores whether a classification model evaluation compound is active or inactive; and a classification model evaluation compound descriptor storage unit that stores descriptors indicating the structure factors and the physicochemical parameters of a classification model evaluation compound compared with the classification model,
wherein the classification model construction unit learns the classification model based on whether the score of the classification model construction compound is high or low and the structure factors and the physicochemical parameters of the classification model construction compound, and
the classification model evaluation unit evaluates the classification model based on whether the classification model evaluation compound is active or inactive and the structure factors and the physicochemical parameters of the classification model evaluation compound.

4. The system for evaluating the performance of an intermolecular interaction predicting apparatus according to claim 2,
wherein, when a prediction score is high, the classification model construction unit sets the target attribute of the classification model construction compound as active, and
when the prediction score is low, the classification model construction unit sets the target attribute of the classification model construction compound as inactive.

5. The system for evaluating the performance of an intermolecular interaction predicting apparatus according to claim 2, further comprising:
an intermolecular interaction predicting apparatus including a bond structure generating unit and a score calculating unit,
wherein the storage device further includes:
a receptor storage unit that stores the receptor; and a classification model construction compound storage unit that stores the classification model construction compound for predicting interaction,
the bond structure generating unit generates bond structures between the receptor stored in the receptor storage unit and all the classification model construction compounds stored in the classification model construction compound storage unit, and
the score calculating unit calculates the scores of all the bond structures generated by the bond structure generating unit.

6. The system for evaluating the performance of an intermolecular interaction predicting apparatus according to claim 5, further comprising a descriptor allocating device,
wherein the storage device further includes a classification model evaluation compound storage unit that stores the classification model evaluation compound used to evaluate the classification model,
the descriptor allocating device allocates descriptors indicating structure factors and physicochemical parameters to each of the classification model construction compounds stored in the classification model construction compound storage unit and stores the descriptors in the classification model construction compound descriptor storage unit, and the descriptor allocating device allocates descriptors indicating structure factors and physicochemical parameters to each of the classification model evaluation compounds stored in the classification model evaluation compound storage unit and stores the descriptors in the classification model evaluation compound descriptor storage unit.

7. The system for evaluating the performance of an intermolecular interaction predicting apparatus according to claim 5, wherein the score calculating unit calculates the binding free energy of the bond structure.

8. The system for evaluating the performance of an intermolecular interaction predicting apparatus according to claim 2,
wherein, in a learning method with a teacher, the classification model construction unit uses a decision tree, ensemble learning, a neural network, a support vector machine, or regression analysis as machine learning, and
in a learning method without a teacher, the classification model construction unit uses clustering or main component analysis as the machine learning.

9. A method of evaluating the performance of an intermolecular interaction predicting apparatus using a correlation between structure factors and physicochemical parameters of classification model construction compounds with high and low scores calculated by the intermolecular interaction predicting apparatus in a performance evaluation system.

10. A method of evaluating the performance of an intermolecular interaction predicting apparatus in a performance evaluation system including a classifying device that evaluates the performance of the intermolecular interaction predicting apparatus using a correlation between structure factors and physicochemical parameters of classification model construction compounds with high and low scores calculated by the intermolecular interaction predicting apparatus,
wherein the classifying device includes:
a classification model construction step of learning a classification model having a high or low score as a target attribute, and structure factors and physicochemical parameters as description attributes; and
a classification model evaluating step of evaluating the constructed classification model.

11. The performance evaluating method according to claim 10,
wherein the system for evaluating the performance of the intermolecular interaction predicting apparatus further includes a storage device including: a classification model construction compound prediction score ranking list storage unit that stores whether the score of the classification model construction compound calculated by the intermolecular interaction predicting apparatus is high or low; a classification model construction compound descriptor storage unit that stores descriptors indicating the structure factors and the physicochemical parameters of the classification model construction compound used to construct the classification model; a classification model evaluation compound active/inactive list storage unit that stores whether a classification model evaluation compound is active or inactive; and a classification model evaluation compound descriptor storage unit that stores descriptors indicating the structure factors and the physicochemical parameters of a classification model evaluation compound compared with the classification model,
the classification model construction step includes a step of learning the classification model based on whether the score of the classification model construction compound is high or low and the structure factors and the physicochemical parameters of the classification model construction compound, and
the classification model evaluating step includes a step of evaluating the classification model based on whether the classification model evaluation compound is active or inactive and the structure factors and the physicochemical parameters of the classification model evaluation compound.

12. The performance evaluating method according to claim 10,
wherein, when a prediction score is high, the classification model construction step sets the target attribute of the classification model construction compound as active, and
when the prediction score is low, the classification model construction step sets the target attribute of the classification model construction compound as inactive.

13. The performance evaluating method according to claim 10,
wherein the storage device further includes:
a receptor storage unit that stores the receptor; and a classification model construction compound storage unit that stores the classification model construction compound for predicting interaction, and
the intermolecular interaction predicting apparatus includes:
a bond structure generating step of generating bond structures between the receptor stored in the receptor storage unit and all the classification model construction compounds stored in the classification model construction compound storage unit; and
a score calculating step of calculating the scores of all the bond structures generated in the bond structure generating step.

14. The performance evaluating method according to claim 13, further comprising:
a descriptor allocating step of allocating descriptors indicating structure factors and physicochemical parameters to each of the classification model construction compounds stored in the classification model construction compound storage unit, storing the descriptors in the classification model construction compound descriptor storage unit, allocating descriptors indicating structure factors and physicochemical parameters to each of the classification model evaluation compounds stored in a classification model evaluation compound storage unit that is provided in the storage device and stores the classification model evaluation compounds used to evaluate the classification model, and storing the descriptors in the classification model evaluation compound descriptor storage means unit.

15. The performance evaluating method according to claim 13,
wherein the score calculating step calculates the binding free energy of the bond structure.

16. The performance evaluating method according to claim 10,
wherein, in a learning method with a teacher, the classification model construction step uses a decision tree, ensemble learning, a neural network, a support vector machine, or regression analysis as machine learning, and
in a learning method without a teacher, the classification model construction step uses clustering or main component analysis as the machine learning.

17. A storage medium for storing a performance evaluating program for allowing a performance evaluation system to evaluate the performance of an intermolecular interaction predicting apparatus using a correlation between structure factors and physicochemical parameters of classification model construction compounds with high and low scores calculated by the intermolecular interaction predicting apparatus.

18. A storage medium for storing a performance evaluating program for allowing a classifying device of a performance evaluation system to evaluate the performance of an intermolecular interaction predicting apparatus using a correlation between structure factors and physicochemical parameters of classification model construction compounds and high and low scores calculated by the intermolecular interaction predicting apparatus,
wherein the classifying device includes:
a classification model construction process of learning a classification model having a high or low score as a target attribute, and the structure factors and the physicochemical parameters as description attributes; and
a classification model evaluating process of evaluating the constructed classification model.

19. The storage medium for storing the performance evaluating program according to claim 18,
wherein the performance evaluation system of the intermolecular interaction predicting apparatus further includes a storage device including: a classification model construction compound prediction score ranking list storage unit that stores whether the score of the classification model construction compound calculated by the intermolecular interaction predicting apparatus is high or low; a classification model construction compound descriptor storage unit that stores descriptors indicating the structure factors and the physicochemical parameters of the classification model construction compound used to construct the classification model; a classification model evaluation compound active/inactive list storage unit that stores whether a classification model evaluation compound is active or inactive; and a classification model evaluation compound descriptor storage unit that stores descriptors indicating the structure factors and the physicochemical parameters of a classification model evaluation compound compared with the classification model,
the classification model construction process includes a process of learning the classification model based on whether the score of the classification model construction compound is high or low and the structure factors and the physicochemical parameters of the classification model construction compound, and
the classification model evaluating process includes a process of evaluating the classification model based on whether the classification model evaluation compound is active or inactive and the structure factors and the physicochemical parameters of the classification model evaluation compound.

20. The storage medium for storing the performance evaluating program according to claim 18,
wherein, when a prediction score is high, the classification model construction process sets the target attribute of the classification model construction compound as active, and
when the prediction score is low, the classification model construction process sets the target attribute of the classification model construction compound as inactive.

21. The storage medium for storing the performance evaluating program according to claim 18,
wherein the storage device further includes:
a receptor storage unit that stores the receptor; and a classification model construction compound storage unit that stores the classification model construction compound for predicting interaction, and
the intermolecular interaction predicting apparatus includes:
a bond structure generating process of generating bond structures between the receptor stored in the receptor storage unit and all the classification model construction compounds stored in the classification model construction compound storage unit; and
a score calculating process of calculating the scores of all the bond structures generated in the bond structure generating process.

22. The storage medium for storing the performance evaluating program according to claim 21, further comprising:
a descriptor allocating process of allocating descriptors indicating structure factors and physicochemical parameters to each of the classification model construction compounds stored in the classification model construction compound storage unit, storing the descriptors in the classification model construction compound descriptor storage unit, allocating descriptors indicating structure factors and physicochemical parameters to each of the classification model evaluation compounds stored in a classification model evaluation compound storage unit that is provided in the storage device and stores the classification model evaluation compounds used to evaluate the classification model, and storing the descriptors in the classification model evaluation compound descriptor storage means unit.

23. The storage medium for storing the performance evaluating program according to claim 21,
wherein the score calculating process calculates the binding free energy of the bond structure.

24. The storage medium for storing the performance evaluating program according to claim 18,
wherein, in a learning method with a teacher, the classification model construction process uses a decision tree, ensemble learning, a neural network, a support vector machine, or regression analysis as machine learning, and
in a learning method without a teacher, the classification model construction process uses clustering or main component analysis as the machine learning.

25. A system for evaluating the performance of an intermolecular interaction predicting apparatus, comprising a classifying device including: classification model construction means for learning a classification model construction unit that learns a classification model having a high or low score as a target attribute, and structure factors and physicochemical parameters as description attributes; and classification model evaluation means for evaluating the constructed classification model.
